(19) United States
(12) Patent Application Publication
(10) Pub. No.: US 2005/0007699 A1
(43) Pub. Date: Jan. 13, 2005

(54) Flying head slider and manufacturing method of the head slider

(75) Inventors: Morihiro Ohno, New Territories (HK); Osamu Fukuroi, New Territories (HK); Ryuji Fujii, New Territories (HK)

Correspondence Address: OBLON, SPIVAK, MCCLELLAND, MAIER & NEUSTADT, P.C., 1940 DUKE STREET, ALEXANDRIA, VA, 22314, US

(73) Assignee: SAE Magnetics (H.K.) Ltd., New Territories (HK)

(21) Appl. No.: 10/884,948

(22) Filed: Jul. 7, 2004

(30) Foreign Application Priority Data
Jul. 10, 2003 (JP) 2003-194914

(51) Int. Cl. G11B 5/60

(52) U.S. Cl. 360/235.7

(57) ABSTRACT

A flying head slider includes at least one head element, a first end surface, near which at least one head element is formed, a second end surface opposite to the first end surface, a bottom surface, and at least one chamfered section formed on at least one edge between at least one of the first and second end surfaces and the bottom surface.

### PRIORITY CLAIM

This application claims priority from Japanese patent application No.2003-194914, filed on Jul. 10, 2003, which is incorporated herein by reference.

### BACKGROUND OF THE INVENTION

1. Field of the Invention

The present invention relates to a flying head slider provided with a thin-film magnetic head element or an optical head element, and to a manufacturing method of the flying head slider.

2. Description of the Related Art

In a magnetic disk drive device, thin-film magnetic head elements for writing magnetic information into and/or reading magnetic information from magnetic disks are in general formed on magnetic head sliders flying in operation above the rotating magnetic disks. The sliders are supported at top end sections of suspensions, respectively.

U.S. Pat. No. 6,396,663 BI discloses a flying magnetic head slider provided with a recess at a corner edge between a trailing surface and an air bearing surface (ABS) of the slider in order to avoid contact of the edge with a magnetic disk surface during flying operations.

However, such magnetic head slider with recess may suffer depositions of contaminations or particles in the recess during operations and it is very difficult to remove such contaminations or particles once deposited in the recess. Recently, in order to increase data storage capacities and densities in the magnetic disk drive apparatus, the flying height of the magnetic head slider lowers more and more. In such low flying height slider, amount of contaminations or particles deposited in the recess may more increase.

### BRIEF SUMMARY OF THE INVENTION

It is therefore an object of the present invention to provide a flying head slider and a manufacturing method of a flying head slider, whereby depositions of contaminations or unnecessary particles onto a lower edge section can be prevented.

According to the present invention, a flying head slider includes at least one head element, a first end surface near which at least one head element is formed, a second end surface opposite to the first end surface, a bottom surface, and at least one chamfered section formed on at least one edge between at least one of the first and second end surfaces and the bottom surface.

Because at least one chamfered section is formed on at least one edge between at least one of the first end surface (trailing surface) and the second end surface (leading surface) and the bottom surface, there is no place for catching contaminations or particles near this edge and thus it is possible to prevent depositions of contaminations and unnecessary particles. Also, the chamfered corner edge of the head slider will reduce generation of chipping of the corner edge during the manufacturing process after the chamfering and will reduce possibility of a crash of the head slider with the disk surface to improve the reliability.

It is preferred that the at least one chamfered section is one chamfered section formed on one edge between one of the first and second end surfaces and the bottom surface, or chamfered sections formed on both edges between the first end surface and the bottom surface and between the second end surface and the bottom surface.

It is also preferred that an angle of the at least one chamfered section with respect to the bottom surface is in a range of 20 to 70 degrees. If the angle between the chamfered section surface and the bottom surface or ABS is in this range, airflow vortexes formed at the air-outlet of the slider in operation become small and thus contaminations or particles caught therein can be reduced.

It is further preferred that a width of the at least one chamfered section is 10 μm or more. In this case, preferably the slider further includes a protection layer formed to cover the at least one head element on the first end surface, and a thickness of the protection layer is equal to or greater than the width of the at least one chamfered section. This allows to prevent shaving of a part of a magnetic pole of the magnetic write head element at chamfering and thus to prevent deterioration in the write operation characteristics.

It is preferred that the at least one head element is at least one thin-film magnetic head element.

According to the present invention, also, a manufacturing method of a flying head slider includes a step of providing a substrate with a plurality of head elements formed thereon, a step of cutting the substrate to separate into a plurality of bar members, each of the bar members having aligned head elements, and a step of chamfering at least one edge between at least one of a first end surface near which the head elements are formed and a second end surface opposite to the first end surface, and a bottom surface to form at least one chamfered section.

Because at least one chamfered section is formed on at least one edge between at least one of the first end surface (trailing surface) and the second end surface (leading surface) and the bottom surface, there is no place for catching contaminations or particles near this edge and thus it is possible to prevent depositions of contaminations and unnecessary particles. Also, the chamfered corner edge of the head slider will reduce generation of chipping of the corner edge during the manufacturing process after the chamfering and will reduce possibility of a crash of the head slider with the disk surface to improve the reliability.

It is preferred that the chamfering step includes chamfering one edge between one of the first and second end surfaces and the bottom surface to form one chamfered section, or chamfering both edges between the first end surface and the bottom surface and between the second end surface and the bottom surface to form chamfered sections.

It is also preferred that the chamfering step includes chamfering the at least one edge to form the at least one chamfered section with an angle in a range of 20 to 70 degrees with respect to the bottom surface. If the angle between the chamfered section surface and the bottom surface is in this range, airflow vortexes formed at the air-outlet of the slider in operation become small and thus contaminations or particles caught therein can be reduced.

It is further preferred that the chamfering step includes chamfering the at least one edge to form the at least one chamfered section with a width of 10 μm or more. In this case, preferably, the method further includes a step of forming a protection layer to cover the at least one head element on the first end surface, a thickness of the protection layer being equal to or greater than the width of the at least one chamfered section.

It is preferred that the method further includes a step of attaching, after the chamfering step, the plurality of bar members to a jig so that the first end surface of one bar member faces to the second end surface of another bar member, a step of forming a redeposition-prevention layer between the bar members, and a step of etching the bottom surfaces of the bar members to form rails on the respective bar members. Because the corner edge of the head slider is chamfered, the redeposition-prevention layer coats the corner edge portion to completely cover the chamfered section. Thus, not only etching of this chamfered section can be prevented but also redeposition of the etched component onto the chamfered section can be prevented. Furthermore, because the corner edge is chamfered, rounding-off will occur at the back from the end surface, namely at a position near a magnetic pole of the magnetic write head element. Therefore, it is possible to reduce the thermal expansion protrusion of the pole or the protection layer due to write current during writing operations.

It is also preferred that the forming step includes forming a redeposition-prevention layer of an epoxy resin layer between the bar members.

It is preferred that the providing step includes providing a substrate with a plurality of thin-film magnetic head elements formed thereon.

Further objects and advantages of the present invention will be apparent from the following description of the preferred embodiments of the invention as illustrated in the accompanying drawings.

### BRIEF DESCRIPTION OF THE SEVERAL VIEWS OF THE DRAWINGS

FIG. 1 is an oblique view illustrating a flying magnetic head slider as a preferred embodiment according to the present invention;

FIG. 2 is an axial section view illustrating the magnetic head slider of the embodiment shown in FIG. 1;

FIGS. 3a and 3b are enlarged axial section views illustrating corner edges between trailing surfaces and bottom surfaces of the conventional magnetic head slider and of the magnetic head slider of the embodiment shown in FIG. 1;

FIG. 4 is a flow chart illustrating a part of a manufacturing process of the magnetic head slider of the embodiment shown in FIG. 1;

FIG. 5 is an oblique view illustrating a plurality of bar members attached to an etching jig in the manufacturing process shown in FIG. 4;

FIGS. 6a and 6b are section views illustrating cover layers for preventing re-deposition of etched particles, of the conventional magnetic head slider and of the magnetic head slider of the embodiment shown in FIG. 1;

FIG. 7 is an axial section view illustrating a magnetic head slider as another embodiment according to the present invention; and

FIG. 8 is an axial section view illustrating a magnetic head slider as further embodiment according to the present invention.

### DETAILED DESCRIPTION OF THE INVENTION

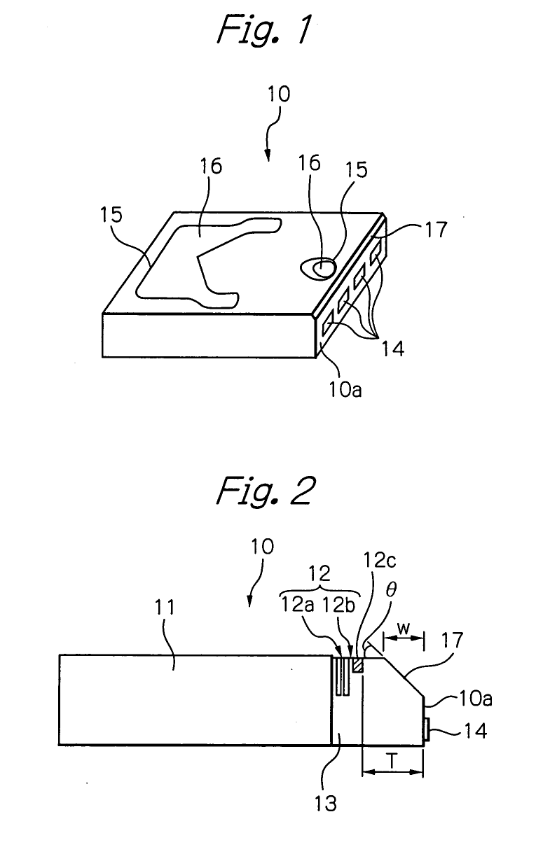

FIG. 1 illustrates a flying magnetic head slider as a preferred embodiment according to the present invention, and FIG. 2 illustrates an axial section of the magnetic head slider of this embodiment.

As shown in these figures, a magnetic head slider 10 substantially consists of a substrate section 11 made of for example Al₂O₃—TiC, thin-film magnetic head elements 12 such as a magnetoresistive effect read head element 12a and an inductive write head element 12b formed on a rear surface (element formed surface) of the substrate section 11, a protection layer 13 made of for example Al₂O₃ for covering the magnetic head elements 12, terminal electrodes 14 electrically connected to the magnetic head elements 12, exposed from the protection layer 13, a plurality of rails 15 formed on a bottom surface of the substrate section 11, and ABSs 16 formed on the respective rails 15.

In this embodiment, a corner edge between a trailing surface 10a and the bottom surface of the slider is chamfered to form a chamfered section 17.

It is desired that an angle θ of a surface of the chamfered section 17 with respect to the bottom surface be in a range of 20-70 degrees. If the angle between the chamfered section surface and the bottom surface is in this range, airflow vortexes formed at the air-outlet of the slider in operation become small and thus contaminations or particles caught therein can be reduced. The surface of the chamfered section 17 is not necessary to be completely flat but some surface asperities may be permitted. If there are surface asperities, an average angle between the surface of the chamfered section 17 and the bottom surface should be in the above-mentioned range.

It is desired that a chamfered width W of the chamfered section 17, that is a distance of an edge between the chamfered section surface and the bottom surface from the trailing surface, is about 10 μm or more. A partial thickness T of the protection layer 13 from an upper end edge of an upper magnetic pole 12c of the write magnetic head element is desirably greater than the chamfered width W in order to prevent deterioration in the write operation characteristics due to shaving of the upper pole 12c at chamfering.

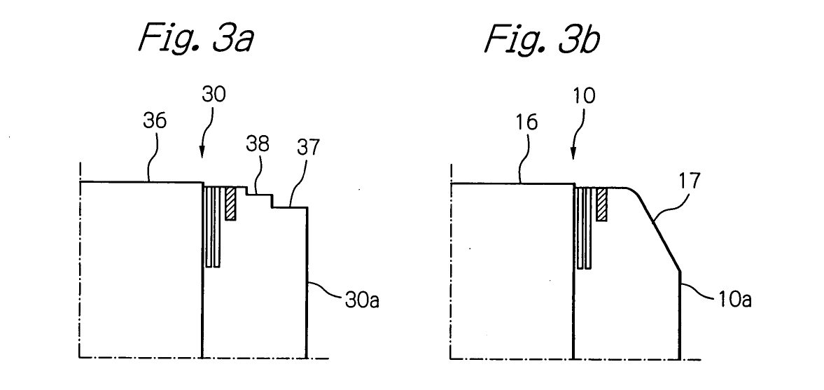

FIGS. 3a and 3b illustrate corner edges between the trailing surfaces and the bottom surfaces of the conventional magnetic head slider and of the magnetic head slider of this embodiment, respectively.

As shown in FIG. 3a, in the conventional magnetic head slider 30, a main recess 37 and a shallow recess 38 are formed near a corner edge between the bottom surface that includes ABS 36 and the trailing surface 30a. In these recesses, particularly in the shallow recess 38, contaminations or particles were easily deposited and it was very difficult to clean or remove such contaminations or particles once deposited in the recess. Whereas in the magnetic head slider 10 of this embodiment, as shown in FIG. 3b, because the chamfered section 17 is formed at the corner edge between the bottom surface and the trailing surface 10a, there is no place for catching contaminations or particles near this corner edge and thus it is possible to prevent depositions of contaminations and unnecessary particles. Also, the chamfered corner edge of the magnetic head slider will reduce generation of chipping of the corner edge during the manufacturing process after the chamfering and will reduce possibility of a crash of the magnetic head slider with the disk surface to improve the reliability.

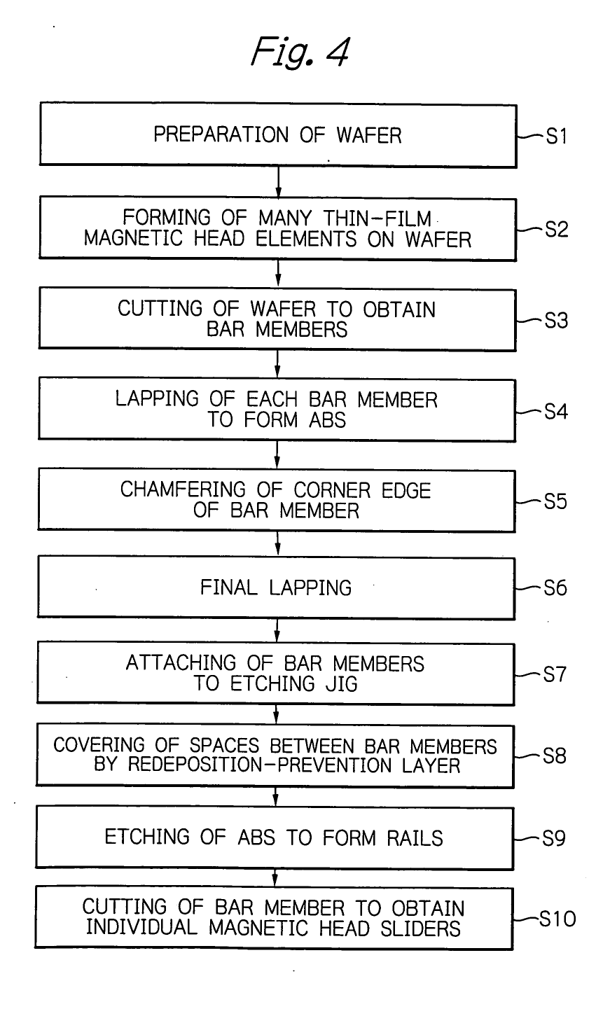

FIG. 4 illustrates flow of a part of a manufacturing process of the magnetic head slider of this embodiment. Hereinafter, the manufacturing method of the magnetic head slider of this embodiment will be described using this drawing as reference.

First, a wafer or substrate made of Al₂O₃—TiC for example is prepared (Step S1).

Then, many thin-film magnetic head elements consisting of MR read head elements and inductive write head elements, many terminal electrodes for the respective thin-film magnetic head elements, and a protection layer are formed on the wafer by using a known thin-film integration technique (Step S2). Thus, a wafer with a thin-film surface layer of the magnetic head elements and their terminal electrodes is obtained.

Then, the wafer is cut to separate into a plurality of bar members each of which has a plurality of aligned magnetic head elements (Step S3).

Then, a bottom surface of each bar member, which surface will configure ABSs is lapped to adjust an MR height and to form the ABSs (Step S4).

Then, a corner edge between the bottom surface and a top surface of each bar member, which top surface will configure the trailing surface of each magnetic head slider is chamfered (Step S5). This chamfering may be performed by lapping, grinding, dry etching or chemical etching. In this case, the chamfering should be executed so that an angle θ of a surface of the chamfered section with respect to the bottom surface, namely ABS, becomes in a range of 20-70 degrees. If the angle between the chamfered section surface and the bottom surface is in this range, airflow vortexes formed at the air-outlet of the magnetic head slider in operation become small and thus contaminations or particles caught therein can be reduced. The surface of the chamfered section is not necessary to be completely flat but some surface asperities may be permitted. If there are surface asperities, an average angle between the surface of the chamfered section and the ABS should be in the above-mentioned range. A chamfered width W of the chamfered section should be about 10 μm or more. A partial thickness T of the protection layer from an upper end edge of an upper magnetic pole of the inductive write head element should be greater than the chamfered width W in order to prevent deterioration in the write operation characteristics due to shaving of the upper pole at chamfering.

Then, the bottom surface of each bar member is finally lapped (Step S6). In general, when the bottom surface is lapped, its corner edge will be rounded off or more shaved. However, according to this embodiment, because the corner edge is chamfered, such rounding will occur at the back from the trailing surface, namely at a position near the upper pole of the inductive write head element. Therefore, it is possible to reduce the thermal expansion protrusion of the pole or the protection layer due to write current during writing operations.

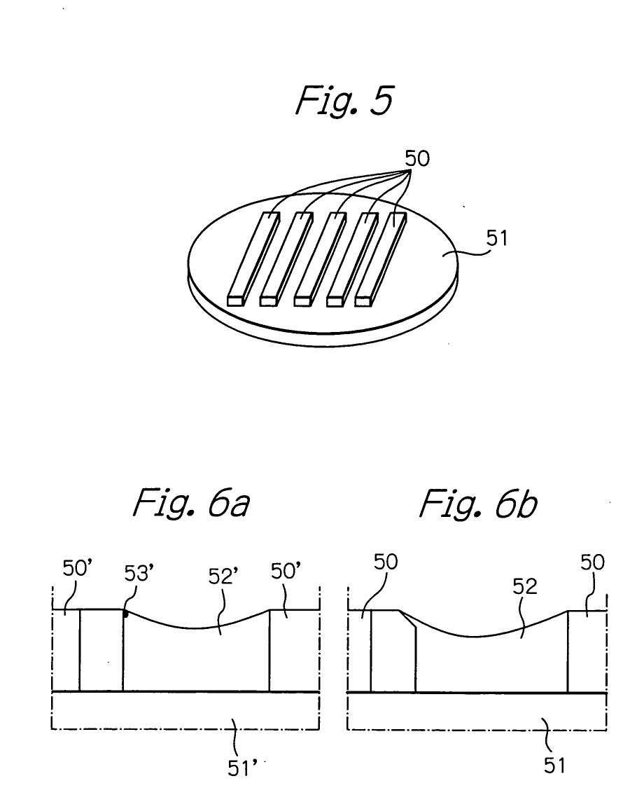

Thereafter, as shown in FIG. 5, the plurality of bar members 50 are arranged in parallel with each other and adhered on an etching jig 51 (Step S7).

Then, as shown in FIGS. 6a and 6b, spaces between the plurality of bar members 50 on the etching jig 51 are covered by a redeposition-prevention layer 52 (Step S8). This cover layer for preventing redeposition 52 is formed by dropping epoxy resin for example into the spaces between the bar members 50.

As shown in FIG. 6a, because no chamfering is performed in the conventional bar member 50′, a corner edge portion between the bottom surface and the top surface of each bar member, which top surface will configure the trailing surface of each magnetic head slider, is not completely covered by the redeposition-prevention layer 52′ and thus redeposition of etched particles 53′ may be produced in the etching process. However, according to the embodiment, as shown in FIG. 6b, because the corner edge of the magnetic head slider is chamfered, the redeposition-prevention layer 52 coats the corner edge portion to completely cover the chamfered section. Thus, not only etching of this chamfered section can be prevented but also redeposition of the etched component onto the chamfered section can be prevented.

In the etching process, the bottom surfaces of the plurality of bar members 50 on the jig 51 are etched by ion milling for example to form a rail pattern (Step S9).

Thereafter, each bar member is cut to separate into individual magnetic head sliders (Step S10).

In modifications, the chamfering process at Step S6 may be performed after the etching process at Step 9. However, in this case, redeposition-prevention effect of etched particles cannot be expected.

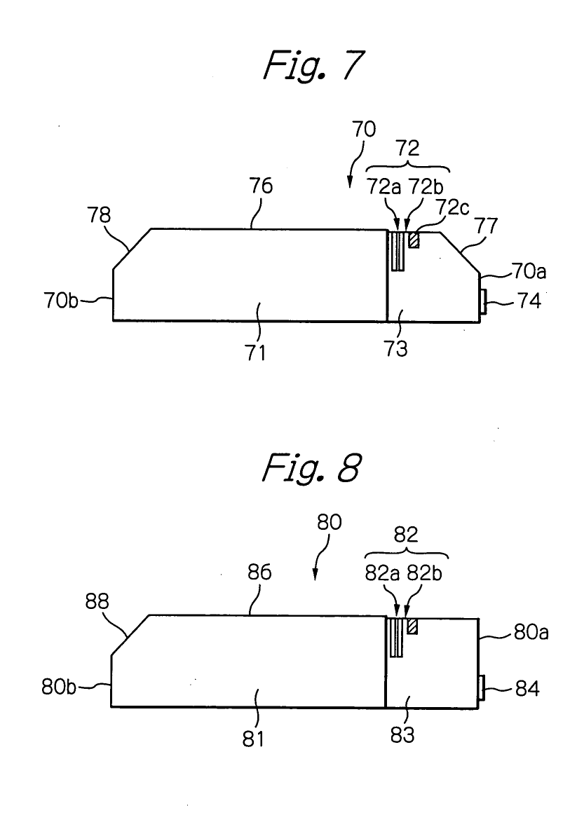

FIG. 7 illustrates a flying magnetic head slider as another embodiment according to the present invention.

As shown in this figure, a magnetic head slider 70 substantially consists of a substrate section 71 made of for example Al₂O₃—TiC, thin-film magnetic head elements 72 such as a magnetoresistive effect read head element 72a and an inductive write head element 72b formed on a rear surface (element formed surface) of the substrate section 71, a protection layer 73 made of for example Al₂O₃ for covering the magnetic head elements 72, terminal electrodes 74 electrically connected to the magnetic head elements 72, exposed from the protection layer 73, a plurality of rails formed on a bottom surface of the substrate section 71, and ABSs 76 formed on the respective rails.

In this embodiment, particularly, both a corner edge between the trailing surface 70a and the bottom surface, and a corner edge between a leading surface 70b that is opposite to the trailing surface 70a and the bottom surface are chamfered to form chamfered sections 77 and 78, respectively.

It is desired that angles of surfaces of the chamfered sections 77 and 78 with respect to the bottom surface, namely ABS 76, be in a range of 20-70 degrees. If the angles between the chamfered section surfaces and the bottom surface are in this range, airflow vortexes formed particularly at the air-outlet of the slider in operation become small and thus contaminations or particles caught therein can be reduced. The surfaces of the chamfered sections 77 and 78 are not necessary to be completely flat but some surface asperities may be permitted. If there are surface asperities, average angles between the surfaces of the chamfered sections 77 and 78 and the ABS 76 should be in the above-mentioned range.

It is desired that chamfered widths of the chamfered sections 77 and 78, that is distances of corner edges between the chamfered section surfaces and the bottom surface from the trailing surface 70a and the leading surface 70b, are about 10 μm or more. It is not necessary that the surface angles, the surface conditions and the chamfered widths of both the chamfered sections 77 and 78 are equal to each other, respectively.

A partial thickness of the protection layer 73 from an upper end edge of an upper magnetic pole 72c of the write magnetic head element is desirably greater than the chamfered width in order to prevent deterioration in the write operation characteristics due to shaving of the upper pole 72c at chamfering.

According to this embodiment, because the chamfered sections are formed both at the corner edge between the bottom surface and the trailing surface and at the corner edge between the bottom surface and the leading surface, there is no place for catching contaminations or particles near these corner edges and thus it is possible to prevent depositions of contaminations and unnecessary particles.

Also, both the chamfered corner edges of the magnetic head slider will reduce generation of chipping of these corner edges during the manufacturing process after the chamfering and will reduce possibility of a crash of the magnetic head slider with the disk surface to improve the reliability.

Furthermore, because both the corner edges of the magnetic head sliders are chamfered, the redeposition-prevention layers coat these corner edge portions to completely cover the chamfered sections, respectively. Thus, not only etching of the chamfered sections can be prevented but also redeposition of the etched component onto the chamfered sections can be prevented.

FIG. 8 illustrates a flying magnetic head slider as further embodiment according to the present invention.

As shown in this figure, a magnetic head slider 80 substantially consists of a substrate section 81 made of for example Al₂O₃—TiC, thin-film magnetic head elements 82 such as a magnetoresistive effect read head element 82a and an inductive write head element 82b formed on a rear surface (element formed surface) of the substrate section 81, a protection layer 83 made of for example Al₂O₃ for covering the magnetic head elements 82, terminal electrodes 84 electrically connected to the magnetic head elements 82, exposed from the protection layer 83, a plurality of rails formed on a bottom surface of the substrate section 81, and ABSs 86 formed on the respective rails.

In this embodiment, particularly, only a corner edge between a leading surface 80b that is opposite to a trailing surface 80a and the bottom surface is chamfered to form a chamfered section 88.

It is desired that an angles of a surface of the chamfered section 88 with respect to the bottom surface, namely the ABS 86, be in a range of 20-70 degrees. If the angle between the chamfered section surface and the bottom surface is in this range, airflow vortexes formed particularly at the air-outlet of the slider in operation become small and thus contaminations or particles caught therein can be reduced. The surface of the chamfered section 88 is not necessary to be completely flat but some surface asperities may be permitted. If there are surface asperities, an average angle between the surface of the chamfered section 88 and the ABS 86 should be in the above-mentioned range. It is desired also that a chamfered width of the chamfered section 88, that is a distance of edge between the chamfered section surface and the bottom surface from the leading surface 80b, is about 10 μM or more.

According to this embodiment, because the chamfered section is formed at the corner edge between the bottom surface and the leading surface, there is no place for catching contaminations or particles near this corner edge and thus it is possible to prevent depositions of contaminations and unnecessary particles.

Also, the chamfered corner edge of the magnetic head slider will reduce generation of chipping of the corner edge during the manufacturing process after the chamfering and will reduce possibility of a crash of the magnetic head slider with the disk surface to improve the reliability.

Furthermore, because the corner edge of the magnetic head sliders is chamfered, the redeposition-prevention layer coats the corner edge portion to completely cover the chamfered section. Thus, not only etching of the chamfered section can be prevented but also redeposition of the etched component onto the chamfered section can be prevented.

In the aforementioned embodiments, the magnetic head sliders with the thin-film magnetic head elements are described. However, it is apparent that the present invention can be applied to a head slider for a head element such as an optical head element other than the thin-film magnetic head element.

Many widely different embodiments of the present invention may be constructed without departing from the spirit and scope of the present invention. It should be understood that the present invention is not limited to the specific embodiments described in the specification, except as defined in the appended claims.

1. A flying head slider comprising:
at least one head element;
a first end surface, said at least one head element being formed near said first end surface;
a second end surface opposite to said first end surface;
a bottom surface; and
at least one chamfered section formed on at least one edge between at least one of said first and second end surfaces and said bottom surface.

2. The head slider as claimed in claim 1, wherein said at least one chamfered section is one chamfered section formed on one edge between one of said first and second end surfaces and said bottom surface.

3. The head slider as claimed in claim 1, wherein said at least one chamfered section is chamfered sections formed on both edges between said first end surface and said bottom surface and between said second end surface and said bottom surface.

4. The head slider as claimed in claim 1, wherein an angle of said at least one chamfered section with respect to said bottom surface is in a range of 20 to 70 degrees.

5. The head slider as claimed in claim 1, wherein a width of said at least one chamfered section is 10 μm or more.

6. The head slider as claimed in claim 5, wherein said slider further comprises a protection layer formed to cover said at least one head element on said first end surface, wherein a thickness of said protection layer is equal to or greater than said width of said at least one chamfered section.

7. The head slider as claimed in claim 1, wherein said at least one head element is at least one thin-film magnetic head element.

8. A manufacturing method of a flying head slider comprising the steps of:
providing a substrate with a plurality of head elements formed thereon;
cutting said substrate to separate into a plurality of bar members, each of said bar members having aligned head elements; and
chamfering at least one edge between at least one of a first end surface near which said head elements are formed and a second end surface opposite to said first end surface and a bottom surface to form at least one chamfered section.

9. The manufacturing method as claimed in claim 8, wherein said chamfering step comprises chamfering one edge between one of said first and second end surfaces and said bottom surface to form one chamfered section.

10. The manufacturing method as claimed in claim 8, wherein said chamfering step comprises chamfering both edges between said first end surface and said bottom surface and between said second end surface and said bottom surface to form chamfered sections.

11. The manufacturing method as claimed in claim 8, wherein said chamfering step comprises chamfering said at least one edge to form said at least one chamfered section with an angle in a range of 20 to 70 degrees with respect to said bottom surface.

12. The manufacturing method as claimed in claim 8, wherein said chamfering step comprises chamfering said at least one edge to form said at least one chamfered section with a width of 10 μm or more.

13. The manufacturing method as claimed in claim 12, wherein said method further comprises a step of forming a protection layer to cover said at least one head element on said first end surface, a thickness of said protection layer being equal to or greater than said width of said at least one chamfered section.

14. The manufacturing method as claimed in claim 8, wherein said method further comprises a step of attaching, after said chamfering step, the plurality of bar members to a jig so that the first end surface of one bar member faces to the second end surface of another bar member, a step of forming a redeposition-prevention layer between the bar members, and a step of etching said bottom surfaces of the bar members to form rails on the respective bar members.

15. The manufacturing method as claimed in claim 14, wherein said forming step comprises forming a redeposition-prevention layer of an epoxy resin layer between the bar members.

16. The manufacturing method as claimed in claim 8, wherein said providing step comprises providing a substrate with a plurality of thin-film magnetic head elements formed thereon.
